(19) United States
(12) Patent Application Publication
(10) Pub. No.: US 2025/0022642 A1
(43) Pub. Date: Jan. 16, 2025

(54) WINDING METHOD FOR HTS COIL

(71) Applicant: Tokamak Energy Ltd, Abingdon Oxfordshire (GB)

(72) Inventors: Jeroen Van Nugteren, Abingdon Oxfordshire (GB); Matthew Bristow, Abingdon Oxfordshire (GB)

(21) Appl. No.: 18/708,853

(22) PCT Filed: Nov. 10, 2022
(86) PCT No.: PCT/EP2022/081459

§ 371 Date: May 9, 2024

(30) Foreign Application Priority Data
Nov. 10, 2021 (GB) 2116158.3

(51) Int. Cl. H01F 6/06; H01F 41/04; H01F 41/074

(52) U.S. Cl. CPC H01F 6/06; H01F 41/048; H01F 41/074

(57) ABSTRACT

A high temperature superconducting. HTS, field coil. The HITS field coil comprises a plurality of HITS tapes (510) arranged to form turns of the HITS field coil, and a substrate (500) separating each of the turns. The turns form a coiled path around an inner perimeter of the field coil, wherein distance from the inner perimeter of the field coil increases monotonically with movement in a first direction along the coiled path. For each HITS tape except the radially innermost HITS tape, each end of the HITS tape is offset in the first direction from the corresponding end of an adjacent HITS tape which is radially inward of the said HITS tape, and the HITS tape overlaps the adjacent HITS tape over at least 50% of the length of the adjacent HTS tape. Each HITS tape has a length less than a perimeter of the coil plus the magnitude of the offset between one end of the HITS tape and the corresponding end of the adjacent HITS tape which is radially outward of the HITS tape.

### FIELD OF THE INVENTION

The present invention relates to the field of high temperature superconducting, HTS, magnets. In particular, the invention relates to a winding method for an HTS coil, a coil resulting from the winding method, and apparatus configured to perform the winding method.

### BACKGROUND

Superconducting materials are typically divided into “high temperature superconductors” (HTS) and “low temperature superconductors” (LTS). LTS materials, such as Nb and NbTi, are metals or metal alloys whose superconductivity can be described by BCS theory. All low temperature superconductors have a self-field critical temperature (the temperature above which the material cannot be superconducting even in zero external magnetic field) below about 30K. The behaviour of HTS material is not described by BCS theory, and such materials may have self-field critical temperatures above about 30K (though it should be noted that it is the physical differences in composition and superconducting operation, rather than the self-field critical temperature, which define HTS and LTS material). The most commonly used HTS are “cuprate superconductors”—ceramics based on cuprates (compounds containing a copper oxide group), such as BSCCO, or ReBCO (where Re is a rare earth element, commonly Y or Gd). Other HTS materials include iron pnictides (e.g. FeAs and FeSe) and magnesium diborate (MgB₂).

ReBCO is typically manufactured as tapes, with a structure as shown in FIG. 1. Such tape 100 is generally approximately 100 microns thick, and includes a substrate 101 (typically an electropolished nickel-molybdenum alloy, e.g Hastelloy™ approximately 50 microns thick), on which is deposited by IBAD, magnetron sputtering, or another suitable technique a series of buffer layers known as the buffer stack 102, of approximate thickness 0.2 microns. An epitaxial ReBCO-HTS layer 103 (deposited by metal oxide chemical vapour deposition (MOCVD) or another suitable technique) overlays the buffer stack, and is typically 1 micron thick. A 1-2 micron silver layer 104 is deposited on the HTS layer by sputtering or another suitable technique, and a copper stabilizer layer 105 is deposited on the tape by electroplating or another suitable technique, which often completely encapsulates the tape. The silver layer 104 and copper stabilizer layer 105 are deposited on the sides of the tape 100 and the substrate 101 too, so that these layers extend continuously around the perimeter of the tape 100, thereby allowing an electrical connection to be made to the ReBCO-HTS layer 103 from either face of the tape 100. These layers 104, 105 may therefore also be referred to as “cladding”. Typically, the silver cladding has a uniform thickness on both the sides and edges of the tape of around 1-2 microns. Providing a silver layer 104 between the HTS layer 103 and the copper layer 105 prevents the HTS material contacting the copper, which might lead to the HTS material becoming poisoned by the copper. The parts of the silver layer 104 and copper stabilizer layer 105 on the sides of the tape 100 are not shown in FIG. 1 for clarity. FIG. 1 also does not show the silver layer 104 extending beneath the substrate 101, as is normally the case. The silver layer 104 makes a low resistivity electrical interface to, and an hermetic protective seal around, the ReBCO layer 103, whilst the copper layer 105 enables external connections to be made to the tape (e.g. permits soldering) and provides a parallel conductive path for electrical stabilisation.

In addition, “exfoliated” HTS tape can be manufactured, which lacks a substrate and buffer stack, but typically has a “surrounding coating” of silver, i.e. layers on both sides and the edges of the HTS layer. Tape which has a substrate will be referred to as “substrated” HTS tape.

An HTS cable comprises one or more HTS tapes, which are connected along their length via conductive material (normally copper). The HTS tapes may be stacked (i.e. arranged such that the HTS layers are parallel), or they may have some other arrangement of tapes, which may vary along the length of the cable. Notable special cases of HTS cables are single HTS tapes, and HTS pairs. HTS pairs comprise a pair of HTS tapes, arranged such that the HTS layers are parallel. Where substrated tape is used, HTS pairs may be type-0 (with the HTS layers facing each other), type-1 (with the HTS layer of one tape facing the substrate of the other), or type-2 (with the substrates facing each other). Cables comprising more than 2 tapes may arrange some or all of the tapes in HTS pairs. Stacked HTS tapes may comprise various arrangements of HTS pairs, most commonly either a stack of type-1 pairs or a stack of type-0 pairs and (or, equivalently, type-2 pairs). HTS cables may comprise a mix of substrated and exfoliated tape.

A superconducting magnet is formed by arranging HTS cables (or individual HTS tapes, which for the purpose of this description can be treated as a single-tape cable) into coils, either by winding the HTS cables or by providing sections of the coil made from HTS cables and joining them together. HTS coils come in three broad classes:
Insulated, having electrically insulating material between the turns (so that current can only flow in the “spiral path” through the HTS cables).
Non-insulated, where the turns are electrically connected radially, as well as along the cables.
Partially insulated, where the turns are connected radially with a controlled resistance, either by the use of materials with a high resistance (e.g. compared to copper), or by providing intermittent insulation between the coils.

Non-insulated coils could also be considered as the low-resistance case of partially insulated coils.

HTS coils are typically manufactured as shown in FIG. 2, by providing a spool 201 of HTS cable 210, with a magnetic brake 202 to apply tension. Then, by moving the spool around the coil (starting with a former or support structure 203 which defines the shape of the coil) or rotating the coil around its axis while keeping the spool stationary, the cable is wound onto the coil turn-by-turn. Additional layers such as insulators, partially insulating layers (i.e. insulators having current paths within them, or materials with a resistance intermediate between a typical insulator and a conductor), quench detection components, or similar, may be wound along with the HTS cable.

This is not suitable for all coil shapes and cable constructions. In particular, stacked tape cables (comprising several parallel HTS tapes which run tangential to the coil at all points) cannot be wound this way on coils with sharp turns, as this will result in heavy strain on tapes at the outside of the turns. For such coils, an alternative winding method may be used as shown in FIG. 3, where the stacked tape cable is built up in-situ by providing a plurality of spools of HTS tape 301a-e, so the HTS tape is wound simultaneously from several spools onto the coil 302. The HTS tapes may be coated in flux as they are wound, and the coil may be later impregnated with solder in order to bond the HTS tapes together, or the HTS tapes may be soldered together as they are wound. The latter is generally preferable for larger coils, to avoid long periods of holding the whole coil at high temperature which would risk degradation of the HTS tape. Similarly to the previous case, other components may be wound between the layers of HTS tape which form each cable.

It is generally difficult to obtain HTS tape of sufficient length that each of the spools of HTS tape in FIG. 3 can hold enough tape for an entire coil. However, HTS tapes may be replaced as each runs out or with a predetermined pattern. The result is a pattern of tape-end to tape-end “butt” joints as shown schematically in FIG. 4 (with the coil “straightened out” and lengths significantly shortened), where each layer of HTS tapes includes a butt joint 401 where the HTS tape stops, and HTS tapes 402 of other layers overlap this butt joint, resulting in an overall pattern similar to typical bricklaying. As noted, the lengths in FIG. 4 are significantly shortened-normally each HTS tape would have a length on the order of meters to hundreds of meters, and a thickness on the order of hundredths to tenths of millimetres.

One disadvantage of the winding method using individual tapes is that the soldering is done all at once. The time that the coil must be held at elevated temperature increases with coil size and winding cross section. This could lead to problems with degradation of the critical current of HTS, if recognized limits on the integral of temperature over time are exceeded. It also makes errors in soldering difficult to detect and to fix. Additionally, for coils carrying large current or operating in extreme environments which require a large number of tapes, the number of individual tape spools presents a challenge in constructing the winding mechanism.

Both of these winding methods make it difficult to introduce “grading” of a coil—i.e. an HTS coil having a zero-field critical current which varies around the coil (generally to compensate for uneven field, temperature, or strain on the coil when in use), as they produce substantially uniform coils. This can be somewhat mitigated by including additional HTS cable or tapes along certain arcs, but this requires additional tooling.

Additionally, the above winding methods are difficult to implement on complex coil shapes, e.g. HTS coils which are not convex shapes in a single plane. For non-convex shapes, special measures must be taken over any concave sections to prevent the HTS tape from “bridging” over those sections, and for non-planar coils the motion of the HTS spool (or the coil itself) can be significantly complex.

Finally, both methods rely on having long lengths of HTS tapes so that the coil can be wound from as few sections of tape or cable as possible. Longer HTS tapes are generally more expensive than an equivalent total length of shorter HTS tapes.

### SUMMARY

[To be Completed when New Claims are Finalised]

According to a first aspect, there is provided a high temperature superconducting, HTS, field coil. The HTS field coil comprises a plurality of HTS tapes arranged to form turns of the HTS field coil, and a substrate separating each of the turns. The turns form a coiled path around an inner perimeter of the field coil, wherein distance from the inner perimeter of the field coil increases monotonically with movement in a first direction along the coiled path. For each HTS tape except the radially innermost HTS tape, each end of the HTS tape is offset in the first direction from the corresponding end of an adjacent HTS tape which is radially inward of the said HTS tape, and the HTS tape overlaps the adjacent HTS tape over at least 50% of the length of the adjacent HTS tape. Each HTS tape has a length less than a perimeter of the coil plus the magnitude of the offset between one end of the HTS tape and the corresponding end of the adjacent HTS tape which is radially outward of the HTS tape.

According to a second aspect, there is provided a method of winding a high temperature superconducting, HTS, field coil. A former is provided, the former defining an inner perimeter of the field coil. A first HTS tape is laid on the former. A plurality of HTS tapes are sequentially laid to form turns of the HTS field coil, each HTS tape overlapping the previous HTS tape over at least 50% of the length of the previous HTS tape, such that that each end of the HTS tape is offset in a first direction around the perimeter of the field coil from the corresponding end of the previous HTS tape. During the laying of the plurality of HTS tapes, a substrate is wound around the field coil to separate the turns formed by the HTS tapes. Each HTS tape has a length less than the perimeter of the field coil plus the magnitude of the offset between one end of the HTS tape and the corresponding end of the next HTS tape.

According to a third aspect, there is provided an apparatus for laying high temperature superconducting, HTS, tape on an HTS field coil. The apparatus comprises an spool, a feeding mechanism, a tape cutter, a propulsion system, and a controller. The spool is configured to hold the HTS tape. The feeding mechanism is configured to dispense HTS tape from the spool onto the HTS field coil. The tape cutter is configured to separate HTS tape laid on the field coil from the HTS tape on the spool. The propulsion system is configured to move the apparatus in both directions around the perimeter of HTS field coil. The controller is configured to:
cause the feeding mechanism to dispense HTS tape onto the HTS field coil while the propulsion system moves the apparatus in a first direction around the perimeter;
after a specified length of HTS tape has been dispensed, cause the tape cutter to separate the dispensed HTS tape from the HTS tape on the spool;
cause the propulsion system to move the apparatus in a second direction around the perimeter;
repeat the steps of dispensing HTS tape, separating the dispensed tape, and moving back in the second direction, such that each HTS tape is dispensed with the start position offset in the first direction from the start position of the previous HTS tape.

Further embodiments are presented in claim 2 et seq.

### BRIEF DESCRIPTION OF THE DRAWINGS

The figures are presented for the illustration of particular concepts only, and should not be taken as exact representations of particular apparatus, methods, or results of methods. Unless otherwise indicated, elements in the figures are not presented to scale, and only those elements required for understanding of the concepts presented are shown (e.g. support structures are generally omitted).

FIG. 1 is an illustration of a high temperature superconducting, HTS, tape.

FIG. 2 is a diagram of a known winding method;

FIG. 3 is a diagram of an alternative known winding method;

FIG. 4 is a simplified cross section of a known HTS cable;

FIGS. 5A to 5E illustrate an exemplary method of laying HTS tapes on an HTS coil;

FIG. 6 illustrates an HTS coil laid with variable offsets;

FIG. 7 is a cross section of a turn of a further exemplary HTS coil, illustrating a particular substrate option;

FIG. 8 is a schematic illustration of an apparatus for laying HTS tapes on an HTS coil; and

FIG. 9 is a schematic illustration of an apparatus for winding an HTS coil;

FIG. 10 is a schematic illustration of a further exemplary method of laying HTS tapes on an HTS coil;

FIG. 11 is a schematic illustration of a turn of an HTS coil laid according to FIG. 10.

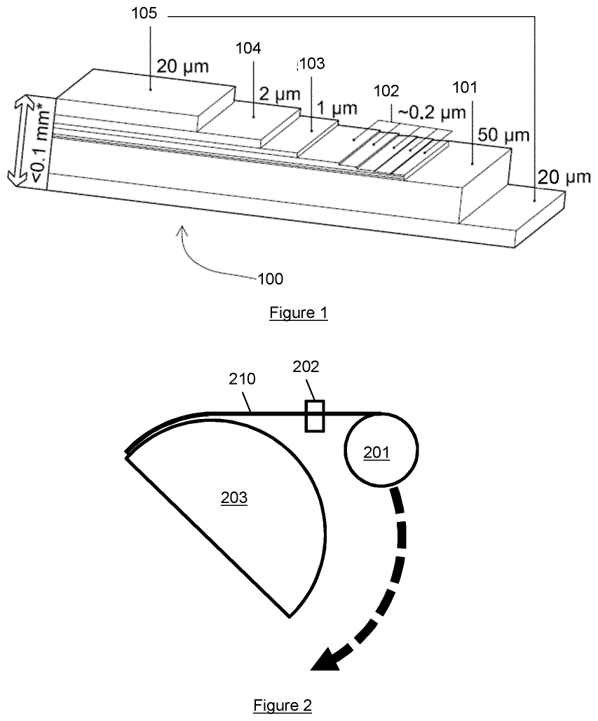

### DETAILED DESCRIPTION

Rather than using the winding processes described in the background, a winding process is described herein which uses a plurality of relatively short lengths of HTS tape which are laid down in an overlapping “shingle-like” pattern.

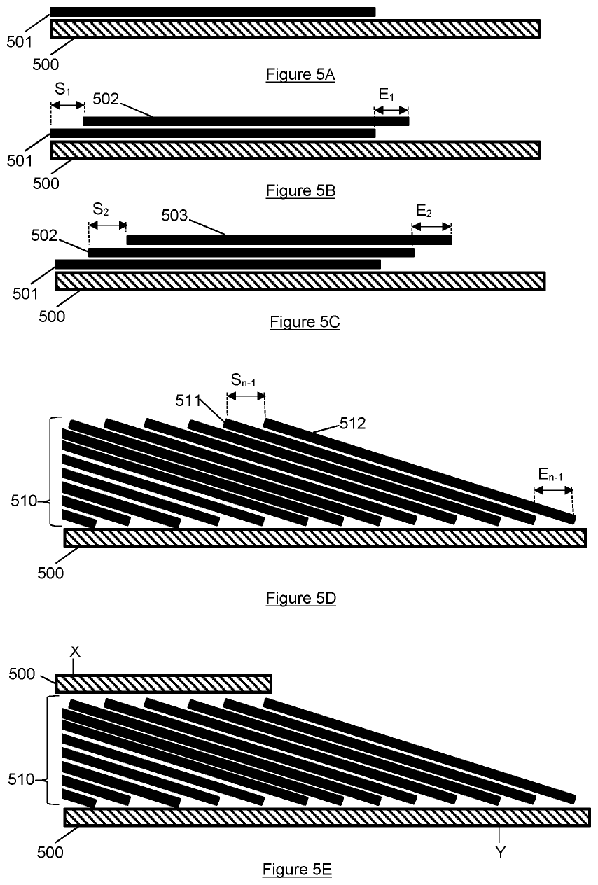

FIGS. 5A to E are a schematic illustration of a simplified method of laying HTS tapes onto a coil. The coil is represented as a flat line, for convenience of illustration, but it will be appreciated that the same principle applies to a wound-up coil.

In FIG. 5A, a first HTS tape 501 is laid onto a substrate 500. The substrate will separate the turns of the HTS coil once constructed, so may be conductive, insulating, or partially insulating as required for the final coil design, and may include additional components such as quench detection components, sensors, or similar. The substrate may change during winding of the coil, e.g. for the initial turn the substrate may be a former or a support structure of the coil, and then change to a substrate having appropriate properties for separating the turns before winding of the second turn begins.

In FIG. 5B, a second HTS tape 502 is laid over the first HTS tape, such that it overlaps a significant portion of the length of the HTS tape 502, with a distance S₁ between the start of the first HTS tape and the start of the second HTS tape, and a distance E₁ between the end of the first HTS tape and the end of the second HTS tape. The distances S₁ and E₁ may be substantially equal (i.e. the first and second HTS tapes may be of the same length), or they may be different (i.e. the HTS tapes may be of different lengths), but the start of the second HTS tape will be further around the coil than the start of the first HTS tape, and the end of the second HTS tape will be further around the coil than the end of the second HTS tape at least in this example. Note that while the HTS tapes are shown as flat and level in this figure and FIGS. 5A and 5C, that is simply for convenience of drawing—the HTS tapes may be laid such that part of the region E₁ lies on the substrate.

In FIG. 5C, a third HTS tape 503 is laid over the second HTS tape, in substantially the same manner as laying the second HTS tape over the first HTS tape—i.e. the third HTS tape overlaps a significant portion of the second HTS tape, with respective distances S₂ and E₂ between the starts of the second and third HTS tape and the ends of the second and third HTS tape.

FIG. 5D shows the result after laying down a plurality of HTS tapes 510. In each case, the “nth” HTS tape overlays the “n−1th” HTS tape, overlapping a significant portion of it with distance Sₙ₋₁ between the start of the n−1th HTS tape 511 (i.e. the previously laid HTS tape) and the nth HTS tape 512 (i.e. the most recently laid HTS tape), and distance Eₙ₋₁ between the end of the n−1th HTS tape and the nth HTS tape. The result is a “shingled” pattern of HTS tapes, where each tape overlaps several tapes which were wound previously, and is overlapped by several tapes which were wound later.

In FIG. 5E, the substrate 500 is overlaid onto the previously placed HTS tapes 510, at most up to the starting point for the next HTS tape to be laid. (it should be noted that this figure is a linear representation of an HTS coil, so the point X on the substrate shown overlaying the HTS tapes may be the same as the point Y on the substrate underlying the HTS tapes further down the figure). By continually laying down additional substrate and further HTS tapes, the HTS coil can be built up to any desired number of turns.

The result of the winding method shown in FIG. 5 is an HTS field coil comprising a plurality of HTS tapes arranged to form turns, and a substrate separating each of the turns. The turns form a coiled path around the inner perimeter of the field coil, where the distance from that inner perimeter increases monotonically with movement in a first direction along the coiled path. For each HTS tape except the innermost tape, each end of the HTS tape is offset in the first direction from the corresponding end of an adjacent HTS tape which is radially inward of the HTS tape, and the HTS tape overlaps the adjacent HTS tape by at least 50% of its length. A 50% overlap would provide a coil having only two tapes in any given cross section of a turn, so in coils with significant current requirements the overlap may be at least 90% (10 tapes per turn cross section) or at least 95% (20 tapes per turn cross section). Each HTS tape has a length less than a perimeter of the coil plus the magnitude of the offset to the next tape (i.e. the adjacent tape which is radially outward). This is the maximum length which allows the next tape to be placed in a position where the substrate has not yet been laid down. Particularly for coils with a high degree of overlap, i.e. where the overlaps are short and on the order of the minimum bending radius of the substrate, the maximum length may be considered as the perimeter of the coil.

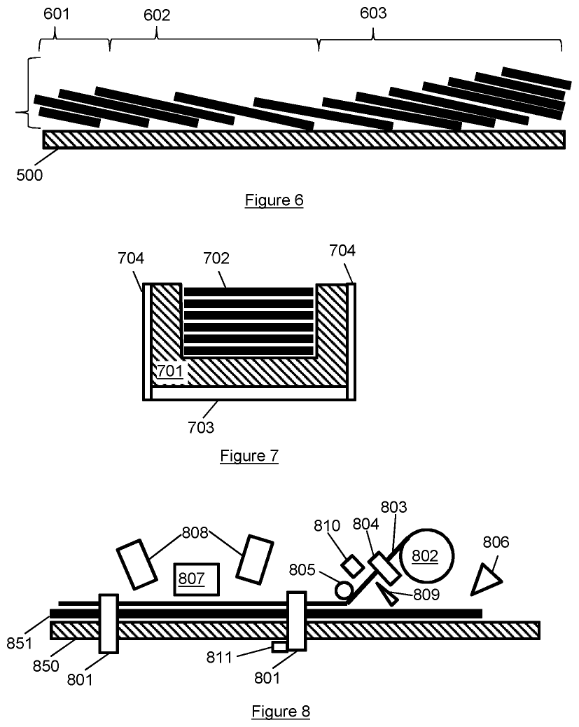

FIG. 6 shows how grading of the coil can be achieved by varying the distances Sₙ Eₙ that the HTS tapes 610 overlap each other. In region 601 the offset distances are such that there are 3 HTS tapes in a cross section of the coil. In region 602, the offset distances are increased, and the coil grades down to only have two HTS tapes in a given cross section. In region 602, the offset distances are reduced, and the coil grades up to having 5 HTS tapes in a given cross section. In general, in areas of the coil where those distances are larger, the number of HTS tapes within a given cross section of the cable will decrease, and where those distances are smaller the number of HTS tapes in a given cross section of the cable will increase. As the zero-field critical current at a given temperature is dependent on the amount of HTS conductor in a cross section of a turn, this will result in grading of the coil. In general the offset distances may vary around the coil, and in a particular example they may vary such that the average offset is greater in a first arc of the coil (reducing the current density in that arc) than in a second arc of the coil (increasing the current density in that arc), for all turns of the coil (i.e. such that the grading of a given arc is similar for all turns).

Depending on the required properties of the final coil, the substrate may be an insulator, a conductive material connecting the turns, a semiconductor, or any combination thereof (e.g. an insulating strip having conductive paths running through it to radially connect the turns with a predetermined resistance). The substrate may comprise a conductive material having a channel within it, and the HTS tape may be laid within that channel, in which case the substrate may additional comprise an insulating layer on the outside of the conductive material to separate the turns, which may or may not have conductive paths through it.

Current flowing through the coil will need to move between HTS tapes as each tape ends. The substantial overlap between tapes means that the resistance introduced by this is very low, and any minor increase in Joule losses can be compensated for by additional cooling of the HTS coil by methods well known in the art. The tapes are fixed by a conductive fixing medium (e.g. solder or a conductive resin such as a conductive epoxy resin, or a resin impregnated with conductive material), and most of the current transfer between tapes will happen within this medium and within the conductive (e.g. copper) cladding on the individual tapes. Further improvements to the resistance may be obtained by providing an additional conductive path which bridges the sides of all tapes, meaning that current flowing from the “bottom” of the tape stack to the “top” of the tape stack only needs to travel through that conductive path, rather than through each intermediate HTS tape. This conductive path may be provided by a separately bonded conductive element, or, as shown in FIG. 7 which is an end-on cross-section of a turn of the coil, the substrate may comprise a u-shaped copper channel 701 into which the HTS tapes 702 are laid, where the sides of the u-shape will form the conductive path. The substrate may comprise additional elements 703, 704 to separate the turns and/or insulate the outer edges of the u-shaped channel.

The HTS tapes may be fixed into place by impregnating the coil with solder or other fixing medium (e.g. conductive resin) after winding. Alternatively, solder or other fixing medium may be co-wound with the HTS tapes and melted, cured, or otherwise induced to fix the tapes during winding. The latter process reduces the time HTS material spends at elevated temperature and also allows the bonding of each HTS tape to be monitored for defects during winding, allowing any mistakes to be detected and potentially corrected (e.g. by reflowing solder, or reversing the bond and rewinding that section of tape) during the winding process.

FIG. 8 shows an exemplary apparatus for laying HTS tapes for the above winding method. The apparatus follows the path of the coil (comprising the substrate 850 and already laid HTS tapes 851), and has guides 801 which maintain its alignment to the coil. The apparatus has an HTS tape spool 802 containing HTS tape 803, which is laid out onto the coil as the apparatus travels in a first direction (right in the figure, hereafter “up the coil” though this should be recognised as a relative direction only), fed out from the spool 802 by a feeding mechanism which comprises an extruder 804 and/or a motor configured to turn the HTS tape spool, and a roller 805 or other similar means which may be spring loaded or similarly biased to press the HTS tape against the already laid tapes of the coil (or the substrate). A bonding agent, e.g. solder paste, a resin such as an epoxy resin, conductive epoxy, or solder flux, is applied via a nozzle or other dispenser 806, located up the coil from roller, such that the deposited bonding agent ends up between the HTS tape 803 and the already laid HTS tapes 851. A bonding agent activator 807 is present (if required) down the coil from the roller, to provide any heating, curing, or other activation required for the bonding agent—for example the bonding agent activator may be a heater which provides heating to a temperature sufficient to melt solder. Sensors 808 may be used down the coil from the roller, e.g. either side of the bonding agent activator, to measure whether the bond between the HTS tape 803 and the already laid HTS tapes 851 is acceptable. These sensors may include cameras, electrical sensors, heat sensors (e.g. thermal cameras or temperature probes) or any other suitable sensor. Determination of whether the bond is acceptable may be based on pre-calibrated values, determination via machine learning based on known good and known bad samples, or human monitoring of sensor outputs or a sample thereof.

The apparatus includes a tape cutter 809, e.g. a knife, located up the coil from the roller, which cuts the tape when the apparatus reaches the location where a given tape should end.

During laying of the tape, the apparatus lays each HTS tape starting from a first end, and continues travelling up the coil and laying the tape until it reaches the desired end point of the tape, at which point the tape is cut and the apparatus continues travelling without feeding out additional tape until the HTS tape is bonded to the previously laid HTS tape all the way to the end. The apparatus then moves back down the coil to the starting point for the next HTS tape, and repeats the process. In this way, the apparatus can lay several HTS tapes along the coil as described with reference to FIG. 5A to E.

A position sensor 810 may be used to monitor the amount of tape dispensed from the HTS tape spool 801, and to determine whether there is sufficient tape remaining to dispense the next HTS tape onto the coil. A further position sensor 811 may be used to determine where on the coil the apparatus is located and so determine when to start and end laying of an HTS tape according to a preconfigured laying pattern for the desired coil.

In effect, the apparatus “rides” over the coil like the cart on a roller-coaster travelling back and forth with tape being laid when it is travelling “up” the coil, then the tape is cut, and then the apparatus travels “down” the coil to the starting point for the next tape. The apparatus may include a propulsion system such as powered wheels, or having the guides alternately grip the coil or support structures thereof and move relative to the apparatus so that it can “crawl” along the coil. Alternatively, the propulsion system may be external to the main apparatus, e.g. a gantry configured to move the apparatus appropriately around the coil.

The operation of the apparatus is controlled by a controller, which may be integral with the apparatus or may be a remote device which sends appropriate inputs to the apparatus. The controller causes the various components of the apparatus to perform the tape laying method as described above. In some implementations the controller may be distributed through several components, e.g. as a distributed computing architecture, or as individual electrical or mechanical control systems for individual parts, which may be coordinated by a central controller.

To ensure that the start of an HTS tape is properly bonded to the coil, the apparatus may move to deposit a patch of bonding agent at the start location of the HTS tape, and then dispense HTS tape onto that patch of bonding agent to form an initial strong bond before continuing to dispense tape.

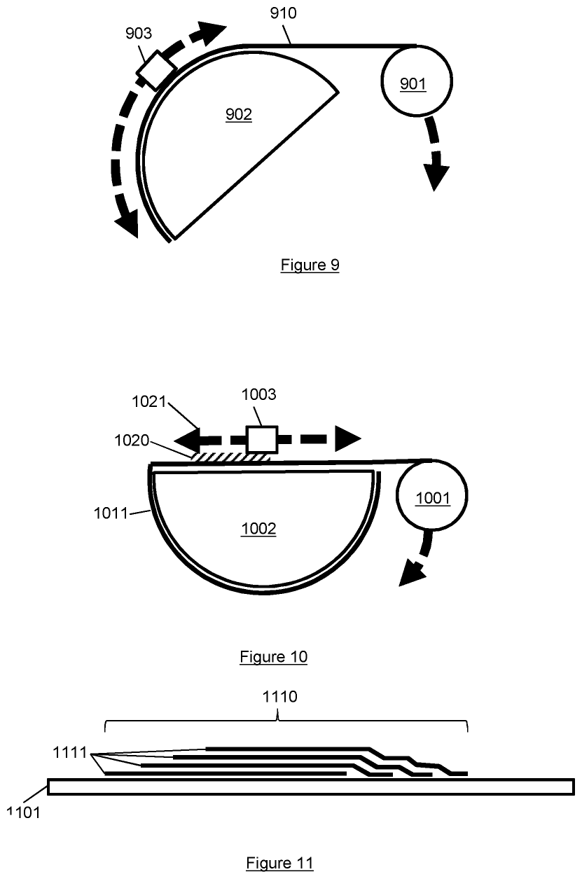

The apparatus shown above will lay the HTS tape according to the example of FIGS. 5A to E, but does not lay the substrate itself. As shown in FIG. 9, this may be done by a separate spool 901 which travels around the coil 902 continuously, e.g. at the average speed of the HTS tape laying apparatus, so that there is always substrate 910 for the HTS tape to be laid onto at the end of an HTS tape length (where it does not overlay any previous tape), but also so that the substrate is not laid on top of the starting location of a not yet laid tape. The apparatus 903 of FIG. 8 then follows this spool, moving back and forth to lay individual HTS tapes.

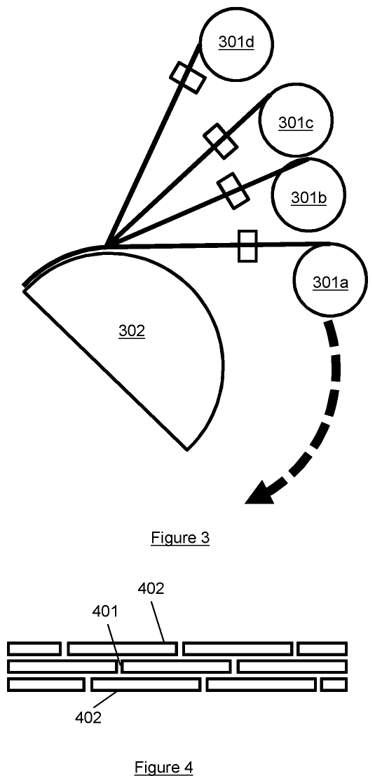

An alternative “hybrid” winding method is shown schematically in FIG. 10. This method combines features of the conventional winding method shown in FIG. 2 or 3, and the novel winding method shown in FIG. 5A-E, and may be advantageous, for example, in situations where the additional resistance introduced by the winding method of FIG. 5A-E is unacceptable. In the hybrid winding method, the coil is wound initially according to the conventional method shown in FIG. 2 or 3, or any other continuous winding method in which an HTS cable is wound to form a field coil. During this winding method—either simultaneously with winding the HTS cable, or during a pause in the winding of the HTS cable—the winding method shown in FIG. 5A-E is used to lay down a plurality of layers of tape in electrical contact with the HTS cable, along an arc of the field coil. These plurality of layers of tape will act as a “shunt” for the HTS cable, which is in electrical contact with the cable and can share current with the HTS cable, thus providing additional current paths (and hence additional current carrying capacity) along the arc of the field coil.

The shunt functions in a similar manner to those described in European Patent EP 3747034 B1, except that instead of a single HTS tape or conventional stack of HTS tapes, the HTS shunt has the arrangement of overlapping tapes discussed above, i.e. where the start and end of each HTS tape of the shunt is offset in one direction around the coil from the start and end of the HTS tape radially inward of it. Similar modifications may be made to the tapes of the HTS shunt as discussed above for a coil wound entirely using the method of FIG. 5—e.g. the spacing of the HTS tapes of the HTS shunt may be varied to control the amount of HTS in any given cross section of the field coil, or an additional conductive path may be provided on the side of the HTS shunt, or any other modification previously discussed.

In the example of FIG. 10, a spool 1001 of HTS cable 1010 is used to provide the main winding 1011 in a manner analogous to the spool 201 and HTS cable 210 of FIG. 2. An apparatus 1003 according to FIG. 8 and the associated description travels along the main winding, and lays down additional HTS tape 1020 in a selected region 1021 (in the example shown, in the central column section of a toroidal field coil) to form the HTS shunt. The apparatus 1003 may follow the main winding spool 201 around the coil (i.e. travelling around the coil outside of the region 1021 but not laying additional tape), or may be removed from the coil when cable is being wound from the main winding spool, and reintroduced whenever a section of additional HTS tape is to be laid down. A plurality of HTS shunts may be added around the coil, and HTS shunts may be added to any number of the turns of the main winding.

FIG. 11 schematically illustrates a close up of a single turn in a region having additional tape, following winding of the coil. The turn comprises the HTS cable forming the field coil 1101 (of which only a section is shown). In the arc 1110, an HTS shunt comprising HTS tapes 1111 is provided on the HTS cable. While only four HTS tapes are shown in the figure, any number of HTS tapes may be used to form the HTS shunt, provided that for each HTS tape other than the radially inner HTS tape, each end of the HTS tape is offset in the first direction from the corresponding end of an adjacent HTS tape which is radially inward of the said HTS tape.

There will be some resistance between the main HTS coil and the HTS shunts, but this will be very low as current can transfer to or from the shunts along their whole length. This is also true if the coil is provided without insulation, such that current can enter the shunts from either side—though where the HTS shunt is made from HTS tapes having substrates, the resistance on the substrate side of the HTS shunt would be higher than that on the HTS side. As such, when the current in the coil is such that if the critical current of the main HTS cable alone is not sufficient in the arc with the shunts to carry the transport current, then excess current will be easily shared to the HTS shunts. At currents less than the critical current of the main HTS cable in the graded region, the vast majority of the current will primarily flow in the main HTS cable. As the HTS cable current approaches the critical current of the parts of the cable experiencing higher magnetic field (or higher temperature, or magnetic field angle less well aligned with the c-axis of the ReBCO HTS layer), the HTS will generate a voltage which will drive excess current through the small resistance between the main cable and the shunt. The voltage generated per metre of HTS (E_{HTS}) is given by E_{HTS}=E₀(I/I_{c})ⁿ where E₀=1 μV/cm is the defined critical current criterion, I_{c} is the critical current of the tape at this criterion, and n is an experimental parameter that models the sharpness of the superconducting to normal transition; n is typically in the range 20-50 for ReBCO. Depending on the value of n, the voltage is negligible for values of α=I/I_{c} less than about 0.8. The excess current above the local critical current will be shared into the shunt. This will happen with minimal dissipation, and the small amount of heat generated will be accommodated by the design of the coil cooling system. The number of shunts, and the number of tapes in each shunt, may be chosen based on the amount of HTS needed to keep the ratio a approximately the same in all parts of the coil. The main HTS cable may have any structure which permits the HTS shunt to be electrically connected to it, for example it may be a stacked tape cable.

Where shunts are provided along an arc of the coil, they may be provided evenly to all turns of the HTS cable (e.g. each turn of the HTS cable may have an HTS shunt comprising two tapes), or the distribution of the shunts may vary across the coil cross section (e.g. providing shunts to every turn towards the outside of the central column for a TF coil, and providing shunts only to every other turn and/or shunts with fewer HTS tapes for turns towards the inside of the central column of a TF coil, as the magnetic field is lower).

While the above example has considered a situation where the HTS shunt is laid down by a method similar to that shown in FIG. 5A-E, the apparatus of FIG. 8 could also be used to lay down an HTS shunt as a more typical stacked tape cable. For example, where each tape overlies a portion of the previously laid down tape (i.e. with each tape being laid down with each end offset towards the centre of the tape relative to the previously laid tape), or where each tape completely overlies the previously laid down tape, or any other arrangement which can be formed by sequentially laying down HTS tapes.

1-28. (canceled)

28. A high temperature superconducting, HTS, field coil comprising:
a plurality of HTS tapes arranged to form turns of the HTS field coil, the turns forming a coiled path around an inner perimeter of the field coil, wherein distance from the inner perimeter of the field coil increases monotonically with movement in a first direction along the coiled path;
a substrate separating each of the turns;
wherein for each HTS tape except the radially innermost HTS tape:
each end of the HTS tape is offset in the first direction from the corresponding end of an adjacent HTS tape which is radially inward of the said HTS tape; and
the HTS tape overlaps the adjacent HTS tape over at least 50% of the length of the adjacent HTS tape
and wherein each HTS tape has a length less than a perimeter of the coil plus the magnitude of the offset between one end of the HTS tape and the corresponding end of the adjacent HTS tape which is radially outward of the HTS tape.

29. An HTS field coil according to claim 28, wherein each HTS tape is bonded to adjacent HTS tapes by one of:
solder paste
solder flux;
a resin; and
a resin impregnated with conductive material.

30. An HTS field coil according to claim 28, wherein the offset between each HTS tape and the adjacent HTS tape varies around the coil.

31. An HTS field coil according to claim 30, wherein the variation in the offset is such that the average offset is greater in a first arc of the coil than in a second arc of the coil, for all turns of the coil.

32. An HTS field coil according to claim 28, wherein the substrate comprises a conductive material having a channel within it, and wherein the HTS tape is within the channel, such that the sides of the channel electrically connect the HTS tapes to each other.

33. An HTS field coil according to claim 28, wherein each the HTS tape overlaps the adjacent HTS tape which is radially inward of the HTS tape over at least 90% of the length of the adjacent HTS tape.

34. A method of winding a high temperature superconducting, HTS, field coil, the method comprising:
providing a former defining an inner perimeter of the field coil;
laying a first HTS tape on the former
sequentially laying a plurality of HTS tapes to form turns of the HTS field coil, each HTS tape overlapping the previous HTS tape over at least 50% of the length of the previous HTS tape, such that that each end of the HTS tape is offset in a first direction around the perimeter of the field coil from the corresponding end of the previous HTS tape;
during the laying of the plurality of HTS tapes, winding a substrate around the field coil to separate the turns formed by the HTS tapes;
wherein each HTS tape has a length less than the perimeter of the field coil plus the magnitude of the offset between one end of the HTS tape and the corresponding end of the next HTS tape.

35. A method according to claim 34, and comprising applying a bonding agent between each HTS tape and the previous HTS tape during or prior to laying of each HTS tape.

36. A method according to claim 35, wherein the bonding agent is solder.

37. A method according to claim 34, wherein the former comprises an initial portion of the substrate, and where the first HTS tape is laid on that initial portion of the substrate.

38. A method according to claim 34, wherein the offset distance between each end of each HTS tape and the corresponding end of the adjacent HTS tape varies around the coil.

39. A method according to claim 38, wherein the variation in the offset is such that the average offset is greater in a first arc of the coil than in a second arc of the coil, for all turns of the coil.

40. Apparatus for laying high temperature superconducting, HTS, tape on an HTS field coil, the apparatus comprising:
a spool configured to hold the HTS tape;
a feeding mechanism configured to dispense HTS tape from the spool onto the HTS field coil;
a tape cutter configured to separate HTS tape laid on the field coil from the HTS tape on the spool;
a propulsion system configured to move the apparatus in both directions around the perimeter of HTS field coil;
a controller configured to:
cause the feeding mechanism to dispense HTS tape onto the HTS field coil while the propulsion system moves the apparatus in a first direction around the perimeter;
after a specified length of HTS tape has been dispensed, cause the tape cutter to separate the dispensed HTS tape from the HTS tape on the spool;
cause the propulsion system to move the apparatus in a second direction around the perimeter;
repeat the steps of dispensing HTS tape, separating the dispensed tape, and moving back in the second direction.

41. A high temperature superconducting, HTS, field coil comprising:
an HTS cable arranged to form a spiral having a plurality of turns;
one or more HTS shunts, each HTS shunt:
being arranged between a respective pair of adjacent turns along an arc of the coil, such that current can be shared between the HTS cable and at least one side of the HTS shunt;
comprising a plurality of HTS tapes such that each HTS tape lies within the arc, and for each HTS tape except the radially innermost HTS tape of each HTS shunt:
each end of the HTS tape is offset in in a first direction around the perimeter of the field coil from the corresponding end of an adjacent HTS tape which is radially inward of the said HTS tape; and
the HTS tape overlaps the adjacent HTS tape over at least 50% of the length of the adjacent HTS tape.

42. A method of manufacturing a high temperature superconducting, HTS, field coil, the method comprising:
winding an HTS cable to provide a field coil having a plurality of turns;
during winding of the HTS cable, placing an HTS shunt adjacent to the previous turn of the coil along an arc of the field coil by:
laying a first HTS tape on the HTS cable
sequentially laying a plurality of HTS tapes to form the HTS shunt, each HTS tape overlapping the previous HTS tape over at least 50% of the length of the previous HTS tape, such that that each end of the HTS tape is offset in a first direction around the perimeter of the field coil from the corresponding end of the previous HTS tape;
winding the HTS cable such that the HTS shunt is sandwiched between the turn and the previous turn of the field coil such that current can be shared between the HTS shunt and the HTS cable.
